(19) United States
(12) Patent Application Publication
(10) Pub. No.: US 2025/0389656 A1
(43) Pub. Date: Dec. 25, 2025

(54) Apparatus And Method For Measuring Fluorescence Lifetime By Using Phasor Deconvolution

(71) Applicant: Korea Advanced Institute of Science and Technology, Daejeon (KR)

(72) Inventors: Hongki YOO, Daejeon (KR); Jeongmoo HAN, Daejeon (KR)

(21) Appl. No.: 19/235,716

(22) Filed: Jun. 12, 2025

(30) Foreign Application Priority Data
Jun. 25, 2024 (KR) 10-2024-0082567

(51) Int. Cl. G01N 21/64

(52) U.S. Cl. CPC G01N 21/6408; G01N 21/645; G01N 2021/6463; G01N 2021/6484

(57) ABSTRACT

Disclosed are an apparatus for measuring a fluorescence lifetime using phasor deconvolution and a method using the same. The apparatus includes an optical system configured to transmit some of excitation light radiated to a fluorophore to a reference signal measuring path, receive fluorescence photons generated by the fluorophore to which the excitation light has been radiated, and transmit the fluorescence photons to a fluorescence signal measuring path, a photo detection unit configured to obtain a reference signal that is received through the reference signal measuring path and a fluorescence signal that is received through the fluorescence signal measuring path, a phasor acquisition unit configured to obtain a fluorophore phasor based on the reference signal and the fluorescence signal, and a fluorescence lifetime calculation unit configured to calculate a fluorescence lifetime of the fluorophore based on the fluorophore phasor.

### CROSS-REFERENCE TO RELATED APPLICATION

The present application claims priority under 35 U.S.C. § 119 (a) to Korean Patent Application No. 10-2024-0082567, filed in the Korean Intellectual Property Office on Jun. 25, 2024, the entire disclosure of which is incorporated herein by reference.

### BACKGROUND

### 1. Technical Field

The present disclosure relates to measuring of a fluorescence lifetime, and more particularly, to an apparatus and method for measuring a fluorescence lifetime by using phasor deconvolution.

### 2. Related Art

In order to measure a fluorescence lifetime, a time-correlated single photon counting (TCSPC) method is conventionally most commonly used. The TCSPC method is performed through a process of illuminating a sample with a laser pulse having very low power, tens of thousands of times or more, measuring the arrival time of photons that are emitted from the sample to which the laser pulse has been excited every pulse, and obtaining a histogram based on the measured arrival time of the photons. The histogram obtained by the TCSPC method exhibits a characteristic of a decay curve over time. A fluorescence lifetime may be primarily obtained through the fitting of an exponential function of the histogram.

The fitting of the exponential function requires a complex computational process. The speed at which the fluorescence lifetime is measured by the TCSPC method is very slow due to the process of excitation of the sample with the laser pulse tens of thousands of times or more. Accordingly, there is a problem in that the conventional method is not suitable for obtaining a real-time imaging.

In order to increase the speed at which the fluorescence lifetime is measured, a method of measuring a fluorescence lifetime based on a response function by system characteristics of an apparatus for measuring a fluorescence lifetime and a measured fluorescence photon may be taken into consideration.

However, such a method also requires a process of excitation of a laser pulse a certain number of times in advance to obtain a response function, which is similar to the TCSPC method. To acquire an instrumental response function with a certain level of accuracy, high-performance digitizers and optical detectors such as a micro channel plate-photo multiplier tube (MCP-PMT) are required, which results in poor cost efficiency in constructing the measurement system. Furthermore, the method suffers from the problem of reduced accuracy in fluorescence lifetime measurements due to the presence of jitter noise from a light source, which is a random noise value.

### PRIOR ART DOCUMENT

### Patent Document

(Patent Document 1) Patent Document 1: Korean Patent No. 10-0885927 (Feb. 26, 2009)

### SUMMARY

For solving such a problem, the present disclosure has an object to provide an apparatus for measuring a fluorescence lifetime using phasor deconvolution and a method therefor.

Furthermore, the present disclosure has an object to provide an apparatus and a method for measuring a fluorescence lifetime using a new method, which is to obtain a high-speed image by rapidly obtaining a fluorescence lifetime by analyzing phasors having a single fluorescence attenuation waveform that is directly obtained by a photodetector, unlike a conventional method of measuring a fluorescence lifetime through which the acquisition of a real-time image is restricted because a laser needs to be oscillated tens of thousands of times or more in order to obtain a fluorescence waveform.

According to an embodiment of the present disclosure, an apparatus for measuring a fluorescence lifetime may be provided. The apparatus may include an optical system configured to transmit some of excitation light radiated to a fluorophore to a reference signal measuring path, receive fluorescence photons generated by the fluorophore to which the excitation light has been radiated, and transmit the fluorescence photons to a fluorescence signal measuring path, a photon detection unit configured to obtain a reference signal that is received through the reference signal measuring path and a fluorescence signal that is received through the fluorescence signal measuring path, a phasor acquisition unit configured to obtain a fluorophore phasor based on the reference signal and the fluorescence signal, and a fluorescence lifetime calculation unit configured to calculate a fluorescence lifetime of the fluorophore based on the fluorophore phasor.

Furthermore, the phasor acquisition unit may obtain the phasor of the fluorescence signal and the phasor of the reference signal and may obtain the fluorophore phasor by deconvolution based on the phasor of the fluorescence signal and the phasor of the reference signal.

Furthermore, the deconvolution based on the phasor of the fluorescence signal and the phasor of the reference signal may be performed by the phasor of the fluorescence signal divided by the phasor of the reference signal.

Furthermore, the fluorescence lifetime calculation unit may be configured to calculate the fluorescence lifetime, based on a real part of the fluorophore phasor, an imaginary part of the fluorophore phasor, and a frequency of the excitation light.

Furthermore, the reference signal measuring path and the fluorescence signal measuring path may include optical fibers having different light path lengths. The photo detection unit may be configured to obtain a pair of the reference signal and the fluorescence signal that are separated at a time interval according to a difference between the light path lengths of the reference signal measuring path and the fluorescence signal measuring path.

Furthermore, the fluorescence signal measuring path may have a longer light path length than the reference signal measuring path.

Furthermore, the fluorophore may include a mixed fluorophore in which a first fluorophore and a second fluorophore are mixed. The phasor acquisition unit may be configured to obtain the phasor of the mixed fluorophore. The apparatus may further include a mixed ratio determination unit configured to determine a mixed ratio of the first fluorophore and the second fluorophore based on a value of the phasor of the mixed fluorophore, which is placed on a line defined by the phasor of the first fluorophore and the phasor of the second fluorophore. The fluorescence lifetime calculation unit may be configured to determine a fluorescence lifetime calculated based on the phasor of the mixed fluorophore as a fluorescence lifetime of the mixed fluorophore having the determined mixed ratio.

According to an embodiment of the present disclosure, a method of measuring a fluorescence lifetime may be provided. The method may include transmitting some of excitation light radiated to a fluorophore to a reference signal measuring path, receiving fluorescence photons generated by the fluorophore to which the excitation light has been radiated, and transmitting the fluorescence photons to a fluorescence signal measuring path, obtaining a reference signal that is received through the reference signal measuring path and a fluorescence signal that is received through the fluorescence signal measuring path, obtaining a fluorophore phasor based on the reference signal and the fluorescence signal, and calculating a fluorescence lifetime of the fluorophore based on the fluorophore phasor. Furthermore, the acquisition of the fluorophore phasor

may includes obtaining the phasor of the fluorescence signal and the phasor of the reference signal and obtaining the fluorophore phasor by deconvolution based on the phasor of the fluorescence signal and the phasor of the reference signal.

Furthermore, the the acquisition the fluorophore phasor by the deconvolution may be performed by dividing the phasor of the fluorescence signal by the phasor of the reference signal.

Furthermore, the calculating of the fluorescence lifetime of the fluorophore may includes calculating the fluorescence lifetime, based on a real part of the fluorophore phasor, an imaginary part of the fluorophore phasor, and a frequency of the excitation light.

Furthermore, the reference signal measuring path and the fluorescence signal measuring path may include optical fibers having different light path lengths. The reference signal and the fluorescence signal may be obtained as a pair of the reference signal and the fluorescence signal that are separated at a time interval according to a difference between the light path lengths of the reference signal measuring path and the fluorescence signal measuring path.

Furthermore, the fluorescence signal measuring path may have a longer light path length than the reference signal measuring path.

According to embodiments of the present disclosure, it is possible to measure a fluorescence lifetime of a fluorophore by using a new method capable of obtaining the fluorescence lifetime at a high speed and accurately through phasor deconvolution using a fluorescence signal and a reference signal that are obtained by single oscillation of a light source.

Furthermore, according to embodiments of the present disclosure, it is possible to construct a simpler and economical measuring system compared to the existing TCSPC method. Furthermore, according to embodiments of the present disclosure, there are advantages in that the phasor of a mixed fluorophore can be analyzed and can be used as a chemical marker by which a degree of metabolism of a cell can be checked because additional analysis using the phasors (i.e., a real part and an imaginary part) is possible in a graph on a two-dimensional phasor plane.

### BRIEF DESCRIPTION OF THE DRAWINGS

FIG. 1 is a schematic diagram illustrating components of an apparatus for measuring a fluorescence lifetime according to an embodiment of the present disclosure.

FIG. 2 is an exemplary graph illustrating a pair of a reference signal and a fluorescence signal that are received by a photo detection unit according to an embodiment of the present disclosure.

FIG. 3 is an exemplary flowchart illustrating a method of measuring a fluorescence lifetime according to an embodiment of the present disclosure.

FIG. 4 is a schematic diagram illustrating the construction of an exemplary measuring system to which the apparatus for measuring a fluorescence lifetime according to an embodiment of the present disclosure has been applied.

FIG. 5 illustrates exemplary graphs each showing the phasor of a single fluorophore obtained by the method of measuring a fluorescence lifetime according to an embodiment of the present disclosure.

FIG. 6 is an exemplary graph illustrating the phasor of a mixed fluorophore obtained by the method of measuring a fluorescence lifetime according to an embodiment of the present disclosure.

FIG. 7 is an exemplary graph illustrating the phasor of a fluorophore, that is, metabolite obtained by the method of measuring a fluorescence lifetime according to an embodiment of the present disclosure.

### DETAILED DESCRIPTION

Hereinafter, embodiments of the present disclosure will be described in detail with reference to the accompanying drawings. First, in adding reference numerals to the components of each drawing, it should be noted that the same components have the same reference numerals as much as possible even if they are displayed in different drawings. Furthermore, in describing the present disclosure, when it is determined that the detailed description of the related well-known configuration or function may obscure the gist of the present disclosure, the detailed description thereof will be omitted.

Various aspects of the present disclosure are described below. Disclosures proposed herein may be implemented in wide and various forms, and it is to be understood that an arbitrary and specific structure, function, or both of them that are proposed herein are only exemplary. A person having ordinary knowledge in the art to which the present disclosure belongs will understand that one aspect proposed herein may be implemented independently of arbitrary other aspects proposed herein based on the disclosures proposed herein and two or more such aspects may be combined in various ways. For example, a device may be implemented or a method may be implemented by using an arbitrary number of aspects described herein. Furthermore, such a device may be implemented or such a method may be implemented in addition to one or more aspect described herein or by using another structure, a function, or a structure and a function other than these aspects.

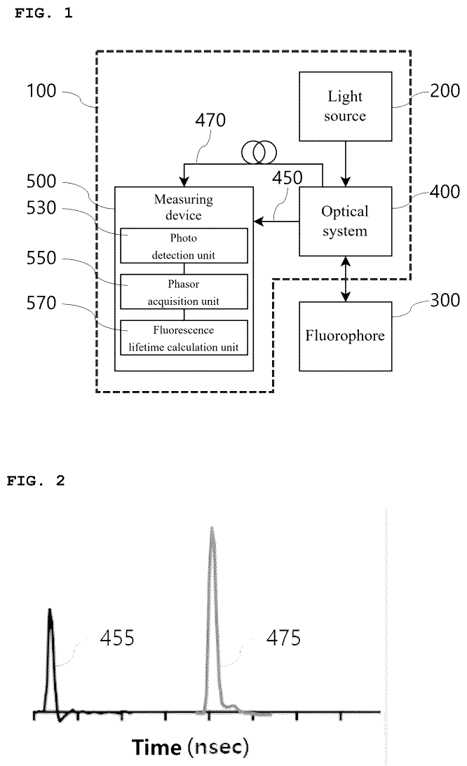

FIG. 1 is a schematic diagram illustrating components of an apparatus for measuring a fluorescence lifetime according to an embodiment of the present disclosure.

As illustrated in FIG. 1, the apparatus 100 for measuring a fluorescence lifetime may include a light source 200, an optical system 400, and a measuring device 500.

The light source 200 may be configured to generate excitation light and to radiate the excitation light to a fluorophore 300. In an implementation example, the light source 200 may be implemented with a pulsed laser for outputting a pulse having a wavelength and frequency which may be set by a user. Furthermore, in FIG. 1, the light source 200 has been exemplified as a component included in the apparatus 100 for measuring a fluorescence lifetime, but the present disclosure is not limited thereto. According to an implementation example, the light source 200 may not be included in the apparatus 100 for measuring a fluorescence lifetime, and may be an external light source capable of outputting excitation light.

The optical system 400 may be configured to transfer, to a reference signal measuring path 450, some of excitation light that is radiated from the light source 200 to the fluorophore 300, and to radiate the remaining excitation light to the fluorophore 300. Furthermore, the optical system 400 may be configured to receive fluorescence photons generated by the fluorophore 300 to which the excitation light has been radiated and to transmit the fluorescence photons to a fluorescence signal measuring path 470.

In an implementation example, the reference signal measuring path 450 and the fluorescence signal measuring path 470 for transmitting some of the excitation light and the fluorescence photons transmitted by the optical system 400, respectively, may each be a cable implemented with an optical fiber. Furthermore, as described below, in order to obtain a reference signal and a fluorescence signal in the form of a pair of separated signals, the reference signal measuring path 450 and the fluorescence signal measuring path 470 may be optical fibers having different light path lengths.

According to an implementation example, the optical system 400 may include a dichroic mirror 410 (410-1 and 410-2) and a light-emitting filter 430 (430-1 to 430-4).

The dichroic mirror 410 may be installed within the optical system 400 so that the dichroic mirror 410 directs some of the pulses of excitation light toward the fluorophore 300 by reflecting the pulses of excitation light depending on a wavelength and directs the remaining pulses of the excitation light toward an input stage of the reference signal measuring path 450 by transmitting the remaining pulses of the excitation light. Furthermore, the dichroic mirror 410 may direct fluorescence photons generated by the fluorophore 300 to which excitation light has been radiated toward the input stage of the fluorescence signal measuring path 470 by transmitting the fluorescence photons. Accordingly, the optical system 400 may transmit separated excitation lights to the reference signal measuring path 450 and the fluorophore 300, respectively, and may transmit the fluorescence photons generated by the fluorophore 300 to the fluorescence signal measuring path 470.

The light-emitting filter 430 may be installed in front of the input stage of the fluorescence signal measuring path 470, and may perform filtering so that only fluorescence photons pass through the light-emitting filter 430. The apparatus 100 for measuring a fluorescence lifetime can obtain a fluorescence lifetime of the fluorophore 300 with high accuracy because the light-emitting filter 430 prevents excitation light from entering the fluorescence signal measuring path 470 through such an operation.

The measuring device 500 is connected to the reference signal measuring path 450 and the fluorescence signal measuring path 470, and may be configured to measure a fluorescence lifetime of the fluorophore 300 based on signals received from the reference signal measuring path 450 and the fluorescence signal measuring path 470. In order to perform such an operation, the measuring device 500 may include a photo detection unit 530, a phasor acquisition unit 550, and a fluorescence lifetime calculation unit 570.

The photo detection unit 530 may be configured to obtain a reference signal 455 that is received through the reference signal measuring path 450 and a fluorescence signal 475 that is received through the fluorescence signal measuring path 470.

According to an implementation example, the reference signal measuring path 450 and the fluorescence signal measuring path 470 may be optical fibers having different light path lengths. Accordingly, the photo detection unit 530 may be configured to obtain the pair of a reference signal 455 and a fluorescence signal 475 that are separated from each other at a time interval according to a difference between the light path lengths of the reference signal measuring path 450 and the fluorescence signal measuring path 470 by single oscillation of the light source 200. For example, the pair of a reference signal 455 and a fluorescence signal 475 that are separated from each other and that are received by the photo detection unit 530 may be exemplified as in FIG. 2.

The fluorescence signal 475 and the reference signal 455 that are received by the photo detection unit 530 may be indicated as a function in a time domain, which is expressed as a convolution product of several factors.

The function of the fluorescence signal 475 in the time domain may be expressed like Equation 1.

$${i}_{flu} ( t ) = C \cdot \{ {I}_{ex} ( t ) ⊗ {Ψ}_{τ} ( t ) ⊗ {I}_{pd} ( t ) \} \qquad ( 1 )$$

In Equation 1, Iex(t) is the waveform of the light source 200, Ψτ(t) is a fluorescence attenuation curve, and Ipd(t) is the response function of a photodetector (i.e., the optical system 400).

The function of the reference signal 455 in the time domain may be expressed like Equation 2.

$${i}_{irf} ( t ) = C \cdot \{ {I}_{ex} ( t ) ⊗ {I}_{pd} ( t ) \} \qquad ( 2 )$$

From Equations 1 and 2, it may be seen that the fluorescence signal 475 received by the photo detection unit 530 is a convolution product of the reference signal 455 and the fluorescence attenuation curve (Ψ(t)).

The phasor acquisition unit 550 may be configured to obtain a fluorophore phasor based on the reference signal 455 and the fluorescence signal 475 received by the photo detection unit 530.

The phasor acquisition unit 550 according to an embodiment of the present disclosure may indicate each of the fluorescence signal 475 and the reference signal 455 having a convolution multiplication relationship in the time domain in the form of a phasor so that the fluorescence signal 475 and the reference signal 455 can be interpreted in a frequency domain. Accordingly, the phasor acquisition unit 550 may obtain the phasor of the fluorescence signal 475 and the phasor of the reference signal 455 based on the fluorescence signal 475 and the reference signal 455 received by the photo detection unit 530, and may obtain the fluorophore phasor by deconvolution based on the phasor of the fluorescence signal 475 and the phasor of the reference signal 455.

In this case, the deconvolution based on the phasor of the fluorescence signal 475 and the phasor of the reference signal 455 may be performed by dividing the phasor of the fluorescence signal 475 by the phasor of the reference signal 455.

Specifically, the phasor (Φflu) of the fluorescence signal 475 may be expressed like Equation 3.

$${ϕ}_{flu} = \frac{{\int }_{0}^{T} {I}_{flu} ( t ) {e}^{i {ω}_{m} t} dt}{{\int }_{0}^{T} {I}_{flu} ( t ) dt} \qquad ( 3 )$$

In Equation 3, Φm is the modulation frequency of excitation light, and may have a value between 20 MHz and 80 MHz, for example.

The phasor (Φirf) of the reference signal 455 may be expressed like Equation 4.

$${ϕ}_{irf} = \frac{{\int }_{0}^{T} {i}_{irf} ( t ) {e}^{i {ω}_{m} t} dt}{{\int }_{0}^{T} {i}_{irf} ( t ) dt} \qquad ( 4 )$$

The phasor acquisition unit 550 may obtain the phasor (i.e., the fluorophore phasor) of only the fluorophore by dividing the obtained phasor of the fluorescence signal 475 by the phasor of the reference signal 455. The fluorophore phasor (Φτ) may be expressed like Equation 5.

$${ϕ}_{r} ≡ \frac{{ϕ}_{flu}}{{ϕ}_{irf}} \qquad ( 5 )$$

As described above, if a phasor is restored by using the pair of a reference signal and a fluorescence signal directly obtained by the apparatus 100 for measuring a fluorescence lifetime, the phasor of only the fluorophore can be accurately calculated although noise, such as jitter noise of the triggering of the light source or the photo detection unit is present. Accordingly, a fluorescence lifetime of the fluorophore 300 can be accurately calculated.

Specifically, noise attributable to the jittering of the light source 200, such as jitter noise, is identically incorporated into both the reference signal and the fluorescence signal every pulse of excitation light. A function that is incorporated into the fluorescence signal and the reference signal when jitter noise having a random characteristic is At may be expressed as follows.

The function of the fluorescence signal 475 in the time domain into which the jitter noise has been incorporated may be expressed like Equation 6.

$${i}_{flu , jitter} ( t ) = C \cdot \{ {I}_{ex} ( t - Δ t ) ⊗ {Ψ}_{τ} ( t ) ⊗ {I}_{pd} ( t - Δ t ) \} \qquad ( 6 )$$

The function of the reference signal 455 in the time domain into which the jitter noise has been incorporated may be expressed like Equation 7.

$${i}_{flu , jitter} ( t ) = C \cdot \{ {I}_{ex} ( t - Δ t ) ⊗ {I}_{pd} ( t - Δ t ) \} \qquad ( 7 )$$

According to Equations 6 and 7, it may be seen that the fluorescence attenuation curve (Ψτ(t)) is not related to jitter noise. The reason for this is that the fluorescence attenuation curve is the characteristic of the fluorophore itself. The fluorophore phasor Φτ may indicate the same value as indicated in Equation 8 even in a situation including jitter noise by using such a characteristic.

$${ϕ}_{τ , jitter} ≡ \frac{{ϕ}_{flu , jitter}}{{ϕ}_{irf , jitter}} = {ϕ}_{τ} \qquad ( 8 )$$

However, in a situation in which the reference signal 455 is not directly obtained, only the phasor of the reference signal in which temporal jittering (i.e., jitter noise) is not considered can be theoretically obtained. Although deconvolution is performed in such a situation, an accurate phasor of only the fluorophore cannot be obtained as expressed in Equation 9.

$${ϕ}_{τ , jitter} ≡ \frac{{ϕ}_{flu , jitter}}{{ϕ}_{irf}} \neq {ϕ}_{τ} \qquad ( 9 )$$

Accordingly, although noise is present, the phasor of only the fluorophore can be obtained at a high speed by directly obtaining the reference signal 455 that is obtained as a pair along with the fluorescence signal 475 according to the proposal of the present disclosure.

The fluorescence lifetime calculation unit 570 may be configured to calculate a fluorescence lifetime of the fluorophore 300 based on the obtained fluorophore phasor Φτ. Specifically, the fluorescence lifetime calculation unit 570 may calculate the fluorescence lifetime of the fluorophore 300 based on a real part “g” of the fluorophore phasor, an imaginary part “s” of the fluorophore phasor, and the frequency “ωm” of the excitation light. First, the fluorophore phasor ot may be expressed like Equation 10.

$${ϕ}_{τ} = \frac{1}{1 + {ω}_{m}^{2} {τ}^{2}} + i \frac{{ω}_{m} τ}{1 + {ω}_{m}^{2} {τ}^{2}} \qquad ( 10 )$$

In Equation 10, om is the modulation frequency of the excitation light, and τ is a time constant (i.e., the fluorescence lifetime).

According to Equation 10, the real part “g” and imaginary part “s” of the fluorophore phasor Φτ may be expressed like Equation 11.

$$g = \frac{1}{1 + {ω}_{m}^{2} {τ}^{2}} , s = \frac{{ω}_{m} τ}{1 + {ω}_{m}^{2} {τ}^{2}} \qquad ( 11 )$$

The fluorescence lifetime “τ” of the fluorophore 300 may be calculated as the function of the real part “g” of the fluorophore phasor, the imaginary part “s” of the fluorophore phasor, and the modulation frequency “ωm” of the excitation light as in Equation 12 based on Equation 11.

$$τ = \frac{1}{{ω}_{m}} \frac{s}{g} \qquad ( 12 )$$

As described above, the apparatus 100 for measuring a fluorescence lifetime according to an embodiment of the present disclosure can accurately calculate the fluorescence lifetime of the fluorophore 300 although jitter noise is present by using phasor deconvolution based on the reference signal 455 that is obtained simultaneously with the fluorescence signal 475, and a simpler and economical measuring system can be constructed because the apparatus 100 does not require a step of measuring excitation light several times in advance in order to obtain a response function of an optical system unlike in a conventional method.

FIG. 2 is an exemplary graph illustrating a pair of a reference signal and a fluorescence signal that are received by the photo detection unit according to an embodiment of the present disclosure.

As illustrated in FIG. 2, the photo detection unit 530 may simultaneously obtain the pair of a reference signal 455 and a fluorescence signal 475 that are separated from each other by single oscillation of the light source. The reference signal 455 and the fluorescence signal 475 may be transmitted to the photo detection unit 530 at a time interval according to a difference between the light path lengths of the reference signal measuring path 450 and the fluorescence signal measuring path 470. In an implementation example, the fluorescence signal measuring path 470 may be configured to have a longer light path length than the reference signal measuring path 450. In such a case, as exemplified in FIG. 2, the fluorescence signal 475 may be transmitted to the photo detection unit 530 at a later time without overlapping the reference signal 455.

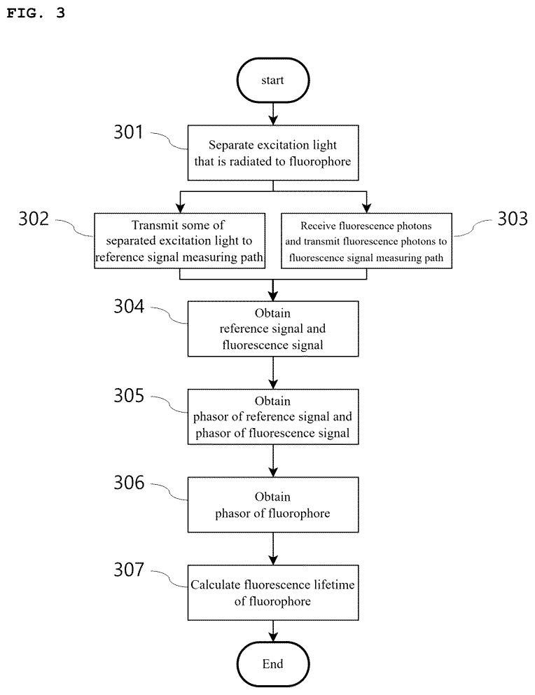

FIG. 3 is an exemplary flowchart illustrating a method of measuring a fluorescence lifetime according to an embodiment of the present disclosure.

As illustrated in FIG. 3, the apparatus 100 for measuring a fluorescence lifetime may separate excitation light that is radiated to the fluorophore 300 (301). The apparatus 100 for measuring a fluorescence lifetime may transmit some of the separated excitation light to the reference signal measuring path 450 (302). At the same time, the apparatus 100 for measuring a fluorescence lifetime may receive fluorescence photons generated by the fluorophore 300 to which the excitation light has been radiated, and may transmit the fluorescence photons to the fluorescence signal measuring path 470 (303). The apparatus 100 for measuring a fluorescence lifetime may obtain the reference signal 455 that is received from the reference signal measuring path 450 and the fluorescence signal 475 that is received from the fluorescence signal measuring path 470 (304). The apparatus 100 for measuring a fluorescence lifetime may obtain the phasor of the reference signal 455 and the phasor of the fluorescence signal 475 (305). The apparatus 100 for measuring a fluorescence lifetime may obtain the phasor of the fluorophore 300 based on the phasor of the reference signal 455 and the phasor of the fluorescence signal 475 (306). The apparatus 100 for measuring a fluorescence lifetime may calculate a fluorescence lifetime of the fluorophore 300 based on the real part of the fluorophore phasor, the imaginary part of the fluorophore phasor, and the frequency of the excitation light (307).

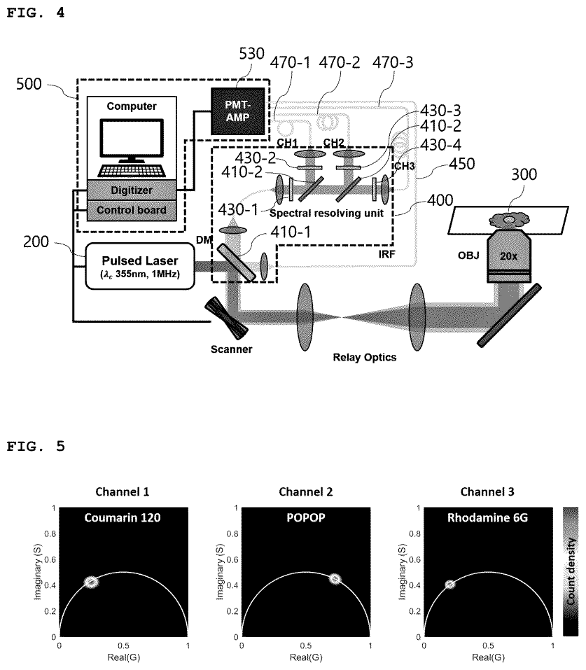

FIG. 4 is a schematic diagram illustrating the construction of an exemplary measuring system to which the apparatus for measuring a fluorescence lifetime according to an embodiment of the present disclosure has been applied.

As illustrated in FIG. 4, the construction of the apparatus 100 for measuring a fluorescence lifetime may be applied and used in an optical measuring system (e.g., a microscope).

The light source 200 of such an optical measuring system may output excitation light including a pulse having a wavelength and frequency (e.g., a wavelength λc of 355 nm and a frequency of 1 MHz in the example of FIG. 4), which is set as a pulsed laser. The optical system 400 may radiate some of the excitation light to the fluorophore 300 (e.g., a fluorescence sample) and transmit the remaining some of the excitation light to the reference signal measuring path 450. Furthermore, the optical system 400 may transmit fluorescence photons that are generated in a region of the fluorophore 300, which is enlarged at selected magnification (e.g., 20 times in the example of FIG. 4) to the fluorescence signal measuring path 470 (470-1, 470-2, and 470-3). The reference signal and the fluorescence signals that are received from the reference signal measuring path 450 and the fluorescence signal measuring paths 470-1, 470-2, and 470-3, respectively, may be transmitted to the measuring device 500. A computer that performs control over the microscope may calculate a fluorescence lifetime of the fluorophore 300 by the phasor deconvolution based on the reference signal and the fluorescence signal as described above. The photo detection unit 530 may include a photomultiplier (PMT) for converting a received optical signal into an electrical signal that the computer can operate and process, and an amplifier (AMP) for amplifying the converted electrical signal, in order to obtain the reference signal and the fluorescence signal.

In FIG. 4, it has been exemplified that the construction of the 100 apparatus for measuring a fluorescence lifetime is applied to the microscope, but the present disclosure is not limited thereto. The construction of the apparatus 100 for measuring a fluorescence lifetime may be applied and used in various measuring devices that use an optical measuring method such as an optical probe, an endoscope and etc.

Furthermore, the apparatus 100 for measuring a fluorescence lifetime may measure a single-channel fluorescence lifetime or a multi-channel fluorescence lifetime (e.g., in FIG. 4) depending on a construction of the optical system 400. The apparatus 100 for measuring a multi-channel fluorescence lifetime may be configured to measure fluorescence lifetimes in various wavelength bands.

In order to implement the apparatus 100 for measuring a multi-channel fluorescence lifetime, the optical system 400 may include the plurality of dichroic mirrors 410-1 and 410-2 and the plurality of light-emitting filters 430-1, 430-2, 430-3, and 430-4. For example, the photo detection unit 530 may obtain the reference signal 455 that is received from the reference signal measuring path 450, and may then sequentially obtain a first fluorescence signal that is received from a first fluorescence signal measuring path 470-1 having a longer length than the reference signal measuring path 450, a second fluorescence signal that is received from a second fluorescence signal measuring path 470-2 having a longer length than the first fluorescence signal measuring path, and a third fluorescence signal that is received from a third fluorescence signal measuring path 470-3 having a longer length than the second fluorescence signal measuring path.

FIG. 5 illustrates exemplary graphs each showing the phasor of a single fluorophore obtained by the method of measuring a fluorescence lifetime according to an embodiment of the present disclosure.

As illustrated in FIG. 5, the fluorophore phasor of each of fluorophores (e.g., Coumarin 120, POPOP, and Rhodamine 6G in FIG. 5) obtained by the apparatus 100 for measuring a fluorescence lifetime may be uniquely indicated in a complex plane graph in which a real part is an x-axis and an imaginary part is a y axis. As may be seen from FIG. 5, the phasor of a single fluorophore may be placed at a unique location for each fluorophore on a semicircular path in the phasor graphs of FIG. 5.

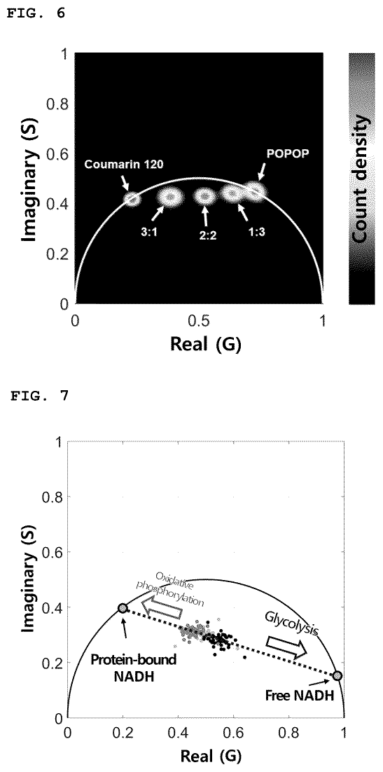

If the fluorophore 300 measured by the apparatus 100 for measuring a fluorescence lifetime is a mixture (i.e., a mixed fluorophore), the phasor of the mixed fluorophore may be placed at a point that falls outside a semicircular path. In such a phasor graph, the location of the phasor of the mixed fluorophore may be indicated as exemplified in FIGS. 6 and 7.

In this case, as will be described below in relation to FIG. 6, if the mixed fluorophore is a mixture of two fluorophores, the phasor of the mixed fluorophore may be placed on a line defined by the locations of the two phasors of the two mixed fluorophores. It may be seen that the ratio of a distance between the location of the phasor of the mixed fluorophore and the locations of the two phasors of the two fluorophores corresponds to the mixed ratio of the two fluorophores.

That is, when the phasor of a first fluorophore and the phasor of a second fluorophore are obtained, a mixed ratio of the first fluorophore and the second fluorophore may be obtained by obtaining the phasor of a mixed fluorophore, that is, a mixture of the first fluorophore and the second fluorophore, through the apparatus 100 for measuring a fluorescence lifetime.

According to an implementation example, the measuring device 500 may further include a mixed ratio determination unit (not illustrated). The mixed ratio determination unit may determine the mixed ratio of the first fluorophore and the second fluorophore based on the value of the phasor of the mixed fluorophore, which is placed on a line defined by the phasor of the first fluorophore and the phasor of the second fluorophore.

In this case, the fluorescence lifetime calculation unit 570 may determine a fluorescence lifetime calculated based on the phasor of the mixed fluorophore as a fluorescence lifetime of the mixed fluorophore having the determined mixed ratio.

FIG. 6 is an exemplary graph illustrating the phasor of a mixed fluorophore obtained by the method of measuring a fluorescence lifetime according to an embodiment of the present disclosure.

As illustrated in FIG. 6, it may be seen that the phasor of a first fluorophore (e.g., Coumarin 120 in FIG. 6) and the phasor of a second fluorophore (e.g., POPOP in FIG. 6) each of which is a pure single fluorophore are placed in the semicircle of the phasor graph. Furthermore, it may be seen that the phasors of mixed fluorophores in which the first fluorophore and the second fluorophore are mixed at different mixed ratios (e.g., 3:1, 2:2, and 1:3 in FIG. 6) are placed at respective points corresponding to the mixed ratios in a line defined by the phasor of the first fluorophore and the phasor of the second fluorophore.

FIG. 7 is an exemplary graph illustrating the phasor of a fluorophore, that is, metabolite obtained by the method of measuring a fluorescence lifetime according to an embodiment of the present disclosure.

If the phasor of a substance related to the metabolism of a cell is obtained by the apparatus 100 for measuring a fluorescence lifetime, which can obtain a fast and accurate fluorescence lifetime, it is possible to evaluate the metabolism state of the cell.

As illustrated in FIG. 7, it is possible to evaluate the metabolism state of a cell by measuring a fluorescence lifetime (e.g., free nicotinamide adenine dinucleotide (NADH): 0.3 nsec, and protein-combined NADH: 2.3 nsec or less) of NADH, which has been known to have a different fluorescence lifetime depending on a chemical bond state, through phasor deconvolution by using the apparatus 100 for measuring a fluorescence lifetime, which has been applied to a self-fluorescent confocal microscope, and indicating the measured fluorescence lifetime in the phasor graph.

FIG. 7 is a diagram illustrating that after a condition for changing the metabolism of a cell was processed, the fluorescence signal of a wavelength band corresponding to NADH within the cell was obtained by the apparatus 100 for measuring a fluorescence lifetime, the phasor of NADH was calculated through phasor deconvolution, and the calculated phasor was indicated in the phasor graph. As may be seen from FIG. 7, it may be seen that different phasor groups are indicated depending on a change into a dominant metabolism path among oxidative phosphorylation and glycolysis. Accordingly, it is possible to check in what path between oxidative phosphorylation and glycolysis (i.e., what ratio) the metabolism of the cell is dominant by indicating and interpreting the phasor of NADH within the cell, the phasor of NADH in the oxidative phosphorylation state, and the phasor of NADH in the glycolysis state in the phasor graph.

The apparatus 100 for measuring a fluorescence lifetime can diagnose and analyze a metabolism path within the cell in real time through the phasor deconvolution method according to an embodiment of the present disclosure by performing such a process for each time zone.

It is to be understood that an arbitrary and specific order or layer structure of steps in arbitrarily proposed processes is an example of exemplary approaches. It is to be understood that a specific order or layer structure of steps in processes may be rearranged within the range of the present disclosure based on design priorities. The attached method claims provide elements of various steps in an exemplary order, but does not mean that the attached method claims are limited to the proposed specific order or layer structure.

A term, such as a “component”, a “unit or part”, a “module”, or a “system” used in this specification, may denote a computer-related entity, hardware, firmware, software, a combination of software and hardware, or the execution of software. For example, the component may be a processing process, a processor, an object, an execution thread, a program and/or a computer that is executed in a processor, but is not limited thereto. For example, both an application being executed in a computing apparatus and a computing apparatus may be components. One or more components may reside in a processor and/or an execution thread. One component may be localized within one computer or may be distributed to two or more computers. Furthermore, such components may be executed from various computer-readable media having various data structures stored therein.

The description of the proposed embodiments is provided so that a person having ordinary knowledge in an arbitrary technical field of the present disclosure can use or implement the present disclosure. Various modifications of such embodiments will be evident to a person having ordinary knowledge in the art of the present disclosure. Common principles defined herein may be applied to other embodiments without departing from the scope of the present disclosure. Accordingly, the present disclosure should not be limited to the proposed embodiments, but should be interpreted in the widest range that is consistent with the proposed principles and new characteristics.

[Description of reference numerals]

| | |
|---|---|
| 100: apparatus for measuring | |
| fluorescence lifetime | |
| 200: light source | 300: fluorophore |
| 400: optical system | 410: dichroic mirror |
| 430: light-emitting filter | |
| 450: reference signal | |
| measuring path | |
| 455: reference signal | |
| 470: fluorescence signal | |
| measuring path | |
| 475: fluorescence signal | 500: measuring device |
| 530: photo detection unit | |
| 550: phasor acquisition unit | |
| 570: fluorescence lifetime | |
| calculation unit | |

What is claimed is:

1. An apparatus for measuring a fluorescence lifetime, comprising:
an optical system configured to transmit some of excitation light radiated to a fluorophore to a reference signal measuring path, receive fluorescence photons generated by the fluorophore to which the excitation light has been radiated, and transmit the fluorescence photons to a fluorescence signal measuring path;
a photo detection unit configured to obtain a reference signal that is received through the reference signal measuring path and a fluorescence signal that is received through the fluorescence signal measuring path;
a phasor acquisition unit configured to obtain a fluorophore phasor based on the reference signal and the fluorescence signal; and
a fluorescence lifetime calculation unit configured to calculate a fluorescence lifetime of the fluorophore based on the fluorophore phasor.

2. The apparatus of claim 1, wherein the phasor acquisition unit obtains a phasor of the fluorescence signal and a phasor of the reference signal and obtains the fluorophore phasor by deconvolution based on the phasor of the fluorescence signal and the phasor of the reference signal.

3. The apparatus of claim 2, wherein the deconvolution based on the phasor of the fluorescence signal and the phasor of the reference signal is performed by dividing the phasor of the fluorescence signal by the phasor of the reference signal.

4. The apparatus of claim 1, wherein the fluorescence lifetime calculation unit is configured to calculate the fluorescence lifetime, based on a real part of the fluorophore phasor, an imaginary part of the fluorophore phasor, and a frequency of the excitation light.

5. The apparatus of claim 1, wherein:
the reference signal measuring path and the fluorescence signal measuring path comprise optical fibers having different light path lengths, and the photo detection unit is configured to obtain a pair of the reference signal and the fluorescence signal that are separated at a time interval according to a difference between the light path lengths of the reference signal measuring path and the fluorescence signal measuring path.

6. The apparatus of claim 5, wherein the fluorescence signal measuring path has a longer light path length than the reference signal measuring path.

7. The apparatus of claim 1, wherein:
the fluorophore comprises a mixed fluorophore in which a first fluorophore and a second fluorophore are mixed,
the phasor acquisition unit is configured to obtain a phasor of the mixed fluorophore,
the apparatus further comprises a mixed ratio determination unit configured to determine a mixed ratio of the first fluorophore and the second fluorophore based on a value of the phasor of the mixed fluorophore, which is placed on a line defined by the phasor of the first fluorophore and the phasor of the second fluorophore, and
the fluorescence lifetime calculation unit is configured to determine a fluorescence lifetime calculated based on the phasor of the mixed fluorophore as a fluorescence lifetime of the mixed fluorophore having the determined mixed ratio.

8. A method of measuring a fluorescence lifetime, comprising:
transmitting some of excitation light radiated to a fluorophore to a reference signal measuring path, receiving fluorescence photons generated by the fluorophore to which the excitation light has been radiated, and transmitting the fluorescence photons to a fluorescence signal measuring path;
obtaining a reference signal that is received through the reference signal measuring path and a fluorescence signal that is received through the fluorescence signal measuring path;
obtaining a fluorophore phasor based on the reference signal and the fluorescence signal; and
calculating a fluorescence lifetime of the fluorophore based on the fluorophore phasor.

9. The method of claim 8, wherein the obtaining of the fluorophore phasor comprises:
obtaining a phasor of the fluorescence signal and a phasor of the reference signal, and
obtaining the fluorophore phasor by deconvolution based on the phasor of the fluorescence signal and the phasor of the reference signal.

10. The method of claim 9, wherein the obtaining the fluorophore phasor by the deconvolution is performed by dividing the phasor of the fluorescence signal by the phasor of the reference.

11. The method of claim 8, wherein the calculating of the fluorescence lifetime of the fluorophore comprises calculating the fluorescence lifetime, based on a real part of the: fluorophore phasor, an imaginary part of the fluorophore phasor, and a frequency of the excitation light.

12. The method of claim 8, wherein:
the reference signal measuring path and the fluorescence signal measuring path comprise optical fibers having different light path lengths, and
the reference signal and the fluorescence signal are obtained as a pair of the reference signal and the fluorescence signal that are separated at a time interval according to a difference between the light path lengths of the reference signal measuring path and the fluorescence signal measuring path.

13. The method of claim 12, wherein the fluorescence signal measuring path has a longer light path length than the reference signal measuring path.
